(19) United States
(12) Patent Application Publication
(10) Pub. No.: US 2007/0181492 A1
(43) Pub. Date: Aug. 9, 2007

(54) Chip carrying type chip filtration and discharge device

(76) Inventors: Tadao Uchiyama, Funabashi-shi (JP); Hyouichi Takahashi, Inba-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/632,300

(22) PCT Filed: Jul. 15, 2005
(86) PCT No.: PCT/JP05/13115

§ 371 Date: Jan. 12, 2007

(30) Foreign Application Priority Data
Jul. 20, 2004 (JP) 2004-211169
Jul. 20, 2004 (JP) 2004-211170

(51) Int. Cl. B23Q 11/00; B01D 33/06; B01D 33/44

(52) U.S. Cl. 210/523

(57) ABSTRACT

A chip carrying type chip filtration and discharge device for separating chips from a cutting lubricant including the chips produced by metal cuttings such as cutting and grinding. The device comprises an apron type conveyor inversed on a conveyor tail part side and a chip carry-out part side and rotatingly running and a filtration drum disposed on the inside of the apron type conveyor. The device is characterized in that a bucket is installed on the inside of the apron type conveyor and, after the chips accumulated at a conveyor tail part is collected by the rotation of the conveyor, the chips are discharged to the outside of the conveyor, and an opening part for flowing out the cutting lubricant after being filtrated by a filtration filter is formed in the filtration drum.

### TECHNICAL FIELD

The present invention relates to a chip carrying type chip filtration and discharge device for separating chips from a cutting lubricant including the chips produced by metal cutting such as cutting and grinding.

### BACKGROUND ART

Variety of conventional filtration devices have been proposed for separating chips from a cutting lubricant including the chips produced by metal cutting with various machine tools and enabling reuse of the cutting lubricant. For example, Japanese Patent Laid-Open No. 2000-202215 (Patent Document 1) discloses a chip carrying type filtration device including a storage tank that stores a liquid to be filtered introduced from an upstream introduction port and has an inclined part toward a discharge port provided in a downstream upper portion, and a hinge conveyor driven along a predetermined track, wherein a filtration drum for introducing and filtering the liquid to be filtered and an injection pipe for washing the filtration filter are provided in a space surrounded by the predetermined track.

Japanese Patent Laid-Open No. 2003-266271 (Patent Document 2) discloses a chip discharge device for separating chips from a turbid coolant including the chips discharged from a machine tool and discharging the chips, wherein the chip discharge device has liquid injection means for removing chips remaining in the device, and the liquid injection means has a liquid discharge pipe having one or more liquid injection holes, and a diffusion plate for reflecting and dispersing an injection stream from the liquid injection holes.

Japanese Patent Laid-Open No. 2002-331438 (Patent Document 3) discloses a chip carry-out conveyor device that can carry and discharge a turbid coolant including large and small chips by a single chip carry-out conveyor device by capturing and carrying out the large chips by a carry-out side belt, and transferring the small chips captured on a return side belt onto a partition plate and carrying the chips so that the chips do not stay in an inversion part of a conveyor tail part.

As a chip carrying type chip discharge device, for example, Japanese Patent Laid-Open No. 2002-361539 (Patent Document 4) proposes a separately collecting mechanism of a chip carry-out conveyor device in which a residual chip collection rate and an oil-drip-like coolant collection rate to a turbid coolant treatment tank are improved, the coolant and the residual chips dropping from a return side belt carrying surface of a hinge belt, and the operability of the normal operation and the maintenance are easy.

Further, Japanese Patent Laid-Open No. 2000-354933 (Patent Document 6) proposes a hinge conveyor device that prevents liquid from dropping out of the lower part of the return side in a hinge conveyor and can collect solid in a dried state, comprising liquid collection means provided with an elastic member that, in a natural state, abuts against or is spaced apart by a predetermined distance from edges of a pair of right and left roller mounting plates that constitute the hinge conveyor, and is elastically deformed, in order to prevent liquid from dropping out of the lower part of the return side in the hinge conveyer driven in an endless state.

Patent Document 1: Japanese Patent Laid-Open No. 2000-202215

Patent Document 2: Japanese Patent Laid-Open No. 2003-266271

Patent Document 3: Japanese Patent Laid-Open No. 2002-331438

Patent Document 4: Japanese Patent Laid-Open No. 2002-361539

Patent Document 5: Japanese Patent Laid-Open No. 2000-354933

However, the invention disclosed in Patent Document 1 relates to the chip carrying type filtration device mainly including the hinge conveyor, a hinge belt is a hinge type chain using one round rod for each hinge with a split pin inserted in a hole at the tip of the rod, or assembled by caulking, and the rod is significantly bent to cause resistance between the hinge and the rod, thereby causing breakage. The hinge belt is connected by the rod and thus cannot be replaced without being taken out. When the belt is to be detached for removing chips remaining in the chip carrying type filtration device, particularly for removing small chips remaining at a conveyor tail part, the belt cannot be detached at this part because the belt is connected by the rod. Further, the chips easily enter and are trapped.

The invention disclosed in Patent Document 2 relates to the chip discharge device comprising, as the liquid injection means for removing chips remaining in the device, the liquid discharge pipe having one or more liquid injection holes, and the diffusion plate for reflecting and dispersing an injection stream from the liquid injection holes. However, the chips are insufficiently discharged from the tail part of the drum part to the outside of the conveyor by the nozzle, and the chips remain in the tail part of the drum part.

The invention disclosed in Patent Document 3 relates to a chip carrying device mainly including a hinge conveyor like Patent Document 1, in which detachment of the belt at part is difficult. The device includes a partition plate and thus has a complicated structure. Also, Patent Document 3 is not a chip carrying device including a filtration drum, thus a slot is provided in the chip carrying device, and the chips remaining in the inversion part of the conveyor tail part can be easily taken out, for example, via the drain slot, and there is little need for preventing chips from remaining in the inversion part of the conveyor tail part in the chip carrying device including the filtration drum as in the present invention.

The invention disclosed in Patent Document 4 as the chip carrying type chip discharge device comprises separating means having a sliding-down plate for sliding down and separating the oil-drip-like coolant and the residual chips dropping from the return side belt carrying surface of the hinge belt, and oil drip collecting means for collecting the oil-drip-like coolant captured by the separating means and circulates it to the turbid coolant treatment tank, and improves the chip collection rate and the coolant thereby. However, draining of the chips and a measure against chips accumulated at the conveyor tail part are insufficient.

Further, the invention disclosed in Patent Document 5 as the chip carrying type chip discharge device is superior for the hinge conveyor device including the liquid collecting means that can collect solid in a dried state, but like Patent Document 4, draining of the chips and a measure against chips accumulated at the conveyor tail part are insufficient.

### DISCLOSURE OF THE INVENTION

In order to solve the above described problems, the inventors have diligently work out development and found the following: The hinge conveyor is replaced by an apron type conveyor to increase strength in a bending structure, open an R part, discharge chips and prevent the chips from being trapped. Unlike the hinge conveyor, the rod is unnecessary to reduce breakage, and the conveyor can be easily replaced by removing right and left bolts. On the other hand, a bucket is installed in a drum to allow the chips on the inside of the conveyor to be scooped and discharged to the outside of the conveyor by the nozzle, thereby providing a chip carrying type chip filtration device for discharging chips on the inside of the conveyor, which can discharge the chips at a tail part of a drum part to the outside of the conveyor.

Further, as the chip discharge device, a chip carrying type chip discharge device is provided in which a distance H from a carrying conveyor is provided in a chip carry-out part, a drainage plate is provided to protrude by a length L from the tip of a drive sprocket in a right upper direction relative to a horizontal direction, further, a swing plate is provided on the drainage plate, rotation of the drive sprocket causes rotation of the swing plate to discharge chips accumulated on the drainage plate from the tip of the drainage plate, and a bucket is provided on the inside of the carrying conveyor to prevent chips from being accumulated at the conveyor tail part, thereby preventing liquid from being carried out with discharge of the chips and dust.

The gist of the invention is as described below:

(1) A chip carrying type chip filtration device comprising: an apron type conveyor inversed on a conveyor tail part side and a chip carry-out part side and rotatingly running; and a filtration drum disposed on the inside of the apron type conveyor, characterized in that a bucket is installed on the inside of the apron type conveyor and, after the chips accumulated at the conveyor tail part are collected by the rotation of the conveyor, the chips are discharged to the outside of the conveyor, and an opening part for flowing out the cutting lubricant after being filtrated by a filtration filter to the outside of the storage tank is formed in the filtration drum.

(2) The chip carrying type chip filtration device according to (1), characterized in that a backwash nozzle for washing the filtration filter and a nozzle for discharging the chips are provided in the filtration drum in the chip carrying type filtration device.

(3) The chip carrying type chip filtration device according to (1), characterized in that chip scraping plates are provided at regular intervals on a chain ring.

(4) A chip carrying type chip discharge device inversed on a conveyor tail part side and a chip carry-out part side and rotatingly running, characterized in that a distance H from a carrying conveyor is provided in the chip carry-out part, and a drainage plate is provided to protrude by a length L from the tip of a drive sprocket in a right upper direction relative to a horizontal direction.

(5) The chip carrying type chip discharge device according to (4), characterized in that a swing plate is provided on the drainage plate, rotation of the drive sprocket causes rotation or reciprocation of the swing plate to discharge chips accumulated on the drainage plate from the tip of the drainage plate.

(6) The chip carrying type chip discharge device according to (4) or (5), characterized in that a bucket is installed on the inside of the carrying conveyor and, after the chips accumulated at the conveyor tail part are collected by the rotation of the conveyor, the chips are discharged to the outside of the conveyor.

As described above, the bucket is provided in the apron type conveyor according to the present invention, thereby allowing the chips accumulated at the conveyor tail part to be discharged, allowing the chips accumulated at the conveyor tail part to be carried to the chip carry-out part side and carried out to the outside of the treatment tank, and allowing the chip discharge device to be operated for a long period without special maintenance.

Further, the drainage plate of the chips is provided in the chip carry-out part according to the present invention, and the swing plate is provided, thereby facilitating discharge of the chips at the chip carry-out part, and preventing liquid from being carried out with discharge of the chips and dust. The bucket is provided on the inside of the carrying conveyor to advantageously prevent the chips from being accumulated at the conveyor tail part, and allow the chip discharge device to be operated for a long period without special maintenance.

Other features and advantages of the present invention will become more apparent from the description below with reference to the accompanying drawings. In the accompanying drawings, the same or similar components are denoted by the same reference numerals.

### BRIEF DESCRIPTION OF THE DRAWINGS

FIG. 1 is a general schematic view of a chip carrying type filtration device according to the present invention;

FIG. 2 is an enlarged view of an apron type conveyor according to the present invention provided with a bucket, at a conveyor tail part and a drive sprocket part;

FIG. 3 is a front sectional view of the apron type conveyor according to the present invention provided with the bucket;

FIG. 4 is a general schematic view of a chip carrying type discharge device according to the present invention;

FIG. 5 is an enlarged view of a chip discharge part according to the present invention; and

FIG. 6 is an illustration of a swing plate according to the present invention.

### DESCRIPTION OF SYMBOLS

1 treatment tank
2 apron type conveyor
2a carry-out side belt
2b return side belt
3 drive sprocket
4 tail disk
5 filtration drum
6 bucket
7 introduction port
8 discharge port
9 filtration filter
10 backwash nozzle
11 opening part
12 chip discharge nozzle
13 partition plate
14 curved structure
15 L-shaped member
16 chips scooped by bucket
17 chips discharged from bucket
18 accumulated chips
19 apron type conveyor plate
20 conveyor plate shaft
21 chain ring
22 chip scraping plate
23 drainage plate
24 swing plate
25 chips
26 chip collecting tank
27 cam
28 arm
29 spring

### BEST MODE FOR CARRYING OUT THE INVENTION

Now, the present invention will be described in detail with reference to the drawings.

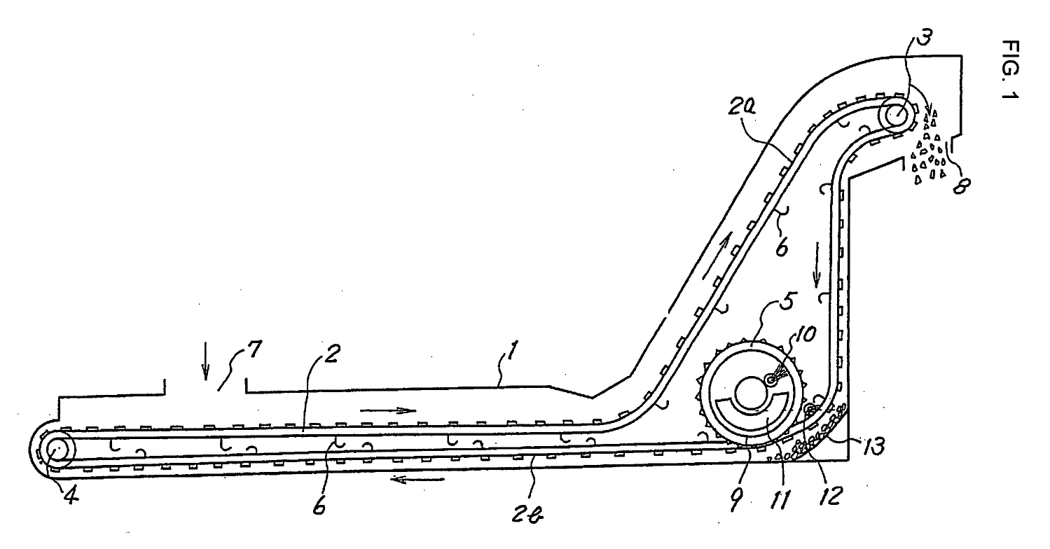

FIG. 1 is a general schematic view of a chip carrying type filtration device according to the present invention. As shown in this figure, the device comprises an apron type conveyor 2 provided in a treatment tank 1 and rotatingly running, a drive sprocket 3 and a tail disk 4 provided at a conveyor tail part, around which the apron type conveyor 2 is wound, the rotatingly running conveyor belt 2 is constituted by a carry-out side belt 2a running on the upper side and a return side belt 2b running on the lower side, and a rotatingly driven filtration drum 5 is provided in a space surrounded by a track of the apron type conveyor 2 in the treatment tank 1.

In the above described configuration, large and small chips produced by metal processing such as cutting and grinding with a machine tool or the like are introduced into the treatment tank 1 from the introduction port 7, and the chips are carried to the drive sprocket 3 by the apron type conveyor 2. In the meantime, the large chips produced by cutting and grinding or the like are discharged from a discharge port 8 via the drive sprocket 3. A cutting lubricant including the small chips and grinding chips drops on the lower side of the apron type conveyor 2, the mixed liquid that is a liquid to be filtered is introduced into the rotatingly driven filtration drum 5 and filtered, and then the cutting lubricant is discharged to the outside of a storage tank.

Thus, a filtration filter 9 is replaceably provided on an outer peripheral surface of the filtration drum 5, and a backwash nozzle 10 for spurting a washed liquid after filtration or air from the inside so as to prevent clogging of the filtration filter 9. Also, a chip discharge nozzle 12 for discharging chips is provided so that the washed liquid injected from the chip discharge nozzle 12 by a pump causes convection in the liquid to be filtered to move the chips to the outside of the return side belt 2b of the apron type conveyor, thereby preventing reattachment and settlement of the chips to the filtration filter. Further, the side surface of the filtration drum 5 is adapted to flow out a washed cutting lubricant after filtration into the treatment tank 1 through an opening part 11.

At this time, small chips that pass without being captured on the carry-out side belt 2a attach to the surface of the filtration drum 5, discharged by the backwash nozzle 10, further discharged to the outside of the return side belt 2b by the chip discharge nozzle 12, and again discharged with large chips to the outside from the carry-out side belt 2a. At this time, fine chips accumulated on the inside of part of the return side belt 2b move toward the conveyor tail side. The fine chips accumulated on the conveyor tail side are collected by a bucket 6 provided on the inside of the belt and inversed at the driving part 3, accumulated on the inside of the return side belt 2b, and discharged to the outside of the return side belt 2b by the chip discharge nozzle 12. Reference numeral 13 denotes a partition plate. The feature of the present invention in this case is that the bucket 6 is provided on the apron type conveyor 2, and the bucket 6 can collect the chips accumulated on the conveyor tail side and again discharge the chips to the outside of the conveyor.

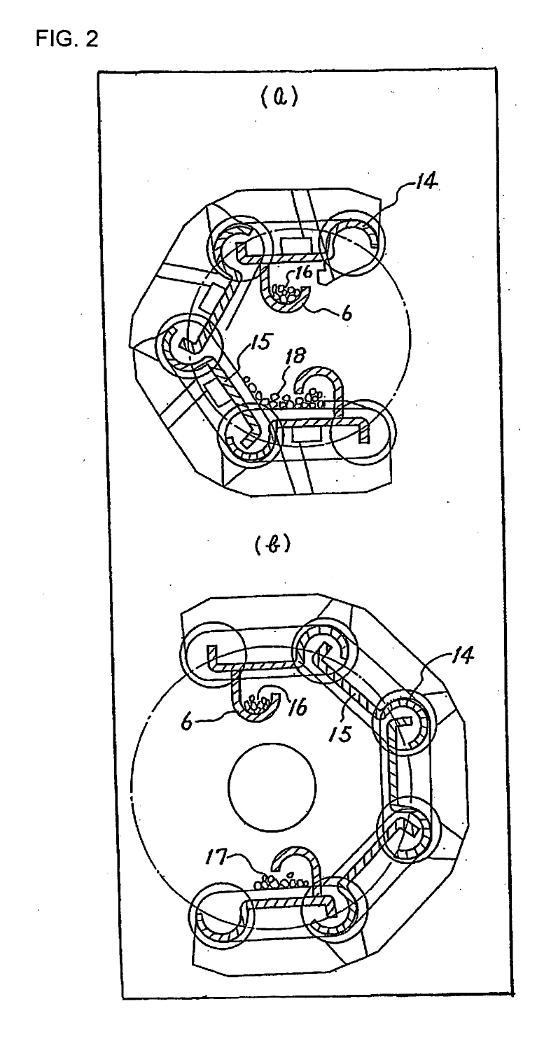

FIG. 2 is an enlarged view of the apron type conveyor according to the present invention provided with the bucket, at a conveyor tail part and a drive sprocket part. FIG. 2a is an enlarged view of the conveyor tail part, and FIG. 2b is an enlarged view of the drive sprocket part. As shown in the figure, unlike a hinge conveyor, the apron type conveyor does not require a rod but uses an L-shaped member 15 having a curved structure 14 at one end to increase strength in a bending structure, open an R part, discharge chips and prevent the chips from being trapped. Unlike the hinge conveyor, the conveyor is not connected by a rod, and thus can be easily replaced by removing right and left bolts. Reference numeral 16 denotes chips scooped by the bucket, 17 denotes chips discharged from the bucket, and 18 denotes accumulated chips.

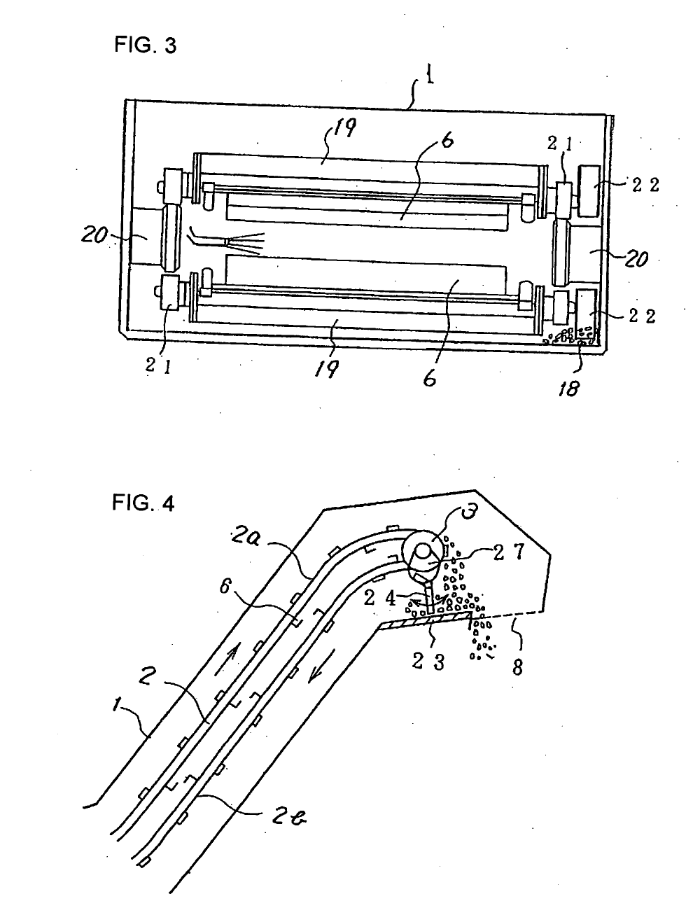

FIG. 3 is a front sectional view of the apron type conveyor according to the present invention provided with the bucket. As shown in the figure, the bucket 6 is installed on an apron type conveyor plate 19, and the bucket 6 scoops small chips accumulated at the conveyor tail part, particularly in inverse running at the conveyor tail part. The small chips are carried with the large chips by the carry-out side belt running on the upper side, filtered by the filtration drum provided in the space of the carrying belt, and discharged to the outside of the treatment tank. Also, chip scraping plates 22 are provided at regular intervals on a chain ring 21 so that chips accumulated in the space between the body bottom of the treatment tank 1 and the chain ring 21 are scooped by the chip scraping plates 22 and discharged to the outside of the treatment tank. Reference numeral 20 denotes a conveyor plate shaft.

As described above, in the present invention, the hinge conveyor is replaced by the apron type conveyor to increase strength in a bending structure, open an R part, discharge chips and prevent the chips from being trapped. Unlike the hinge conveyor, the rod is unnecessary to reduce breakage, and the conveyor can be easily replaced by removing right and left bolts. On the other hand, the bucket is installed on the conveyor to allow the chips on the inside of the conveyor to be scooped and discharged to the outside of the conveyor by the nozzle, thereby allowing the chips accumulated at the conveyor tail part to be carried to the chip carry-out part side and carried out to the outside of the treatment tank, and allowing the chip discharge device to be operated for a long period without special maintenance.

FIG. 4 is a general schematic view of a chip carrying type discharge device according to the present invention. As shown in the figure, the device comprises a conveyor 2 provided in a treatment tank 1 and rotatingly running, a drive-sprocket 3 and a tail disk 4 around which the conveyor 2 is wound, and the rotatingly running conveyor belt 2 is constituted by a carry-out side belt 2a running on the upper side and a return side belt 2b running on the lower side.

In the above described configuration, large and small chips produced by metal processing such as cutting and grinding with a machine tool or the like are introduced into the treatment tank 1 from an introduction port 7, and the chips are carried to the drive sprocket 3 by the conveyor 2. In the meantime, the large chips produced by cutting or the like are discharged from a discharge port 8 via the drive sprocket 3. A cutting lubricant including the small chips and grinding chips drops on the lower side of the conveyor 2, and the mixed liquid is discharged to the outside.

In the lower portion of the drive sprocket at the chip discharge part of the chip carrying conveyor device, a swing plate 24 is provided on a drainage plate 23, rotation of the chip carrying conveyor causes rotation or reciprocation of the swing plate 24 with the drive sprocket 3 to move chips accumulated on the drainage plate 23 to the tip of the drainage plate 23 and discharge the chips. This allows the chips accumulated on the drainage plate 23 to be drained and discharged from the discharge port 8 by the swing plate 24 on the carry-out side, without being accumulated on the side of the treatment tank 1. In reciprocation of the swing plate 24, the swing plate 24 can be horizontally moved on the drainage plate 23, and thus the swing plate 24 can always move forward chips remaining in a clearance between the drainage plate 23 and the swing plate 24 without moving the chips to the rear in the return of the swing plate 24.

The above described drainage plate 23 is a plate not only for drainage but for separating liquid material including mixed liquid such as a cutting lubricant, because the present invention is intended for separating the chips from the cutting lubricant including the chips produced by metal cutting such as cutting and grinding. The carrying conveyor may be a plate-like (or caterpillar-like) conveyer such as a hinge conveyor, an apron type conveyor, or a belt conveyor. The conveyor is not limited, and may be a conveyor that can carry chips and dust, or the like.

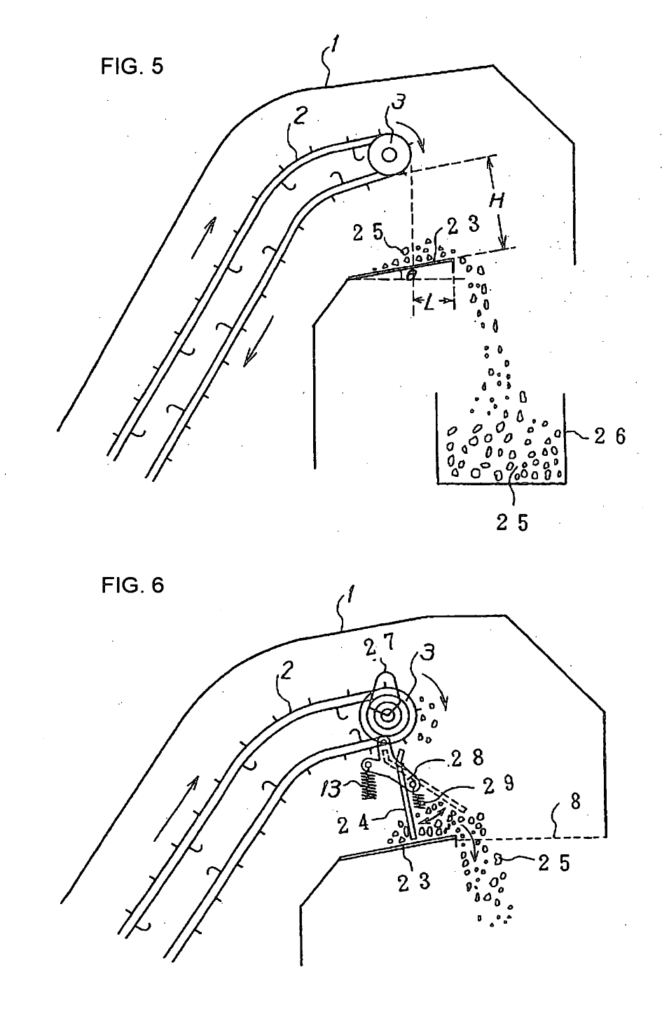

FIG. 5 is an enlarged view of a chip discharge part according to the present invention. As shown in the figure, a distance H is provided below the drive sprocket 3. The distance H required is such that rotation of the drive sprocket 3 can cause sufficient rotation of the swing plate 24. The drainage plate 23 is provided in a right upper direction relative to a horizontal direction to protrude by a length L from the tip of the drive sprocket 3.

The drainage plate 23 is provided in the right upper direction relative to the horizontal direction. This is because when chips carried by the chip carrying conveyor drop immediately below the drive sprocket 3 by the rotation of the drive sprocket 3, with the drainage plate 23 horizontally provided, chips 25 accumulated on the drainage plate 23 are collected in a chip collecting tank 26 without oil and water of the chips 25 completely drained, and thus, in order to completely separate the oil and water, the chips having dropped immediately below the drive sprocket 3 are drained on the drainage plate 23 for sufficient time and then collected in the chip collecting tank 26. For this purpose, the drainage plate 23 is preferably provided at an inclined angle θ of 1 to 10° from the horizontal plane. The above described advantage is insufficient with the angle of less than 1°, and large chips tend to drop on the lower portion of the treatment tank 1 with the angle of more than 10°, which are unpreferable. Thus, the angle of 3 to 7° is preferable.

The protruding length L of the drainage plate 23 is preferably ⅕ H to ½ H from the position where the chips carried by the chip carrying conveyor drop immediately below the drive sprocket 3 by the rotation of the drive sprocket 3. The advantage of drainage is insufficient with the length L of less than ¼ H, and sufficient drainage advantage can be obtained with the length of more than ½ H but transfer energy increases for collecting the chips in the chip collecting tank 26, which are unpreferable. A more preferable range is ¼ H to ⅓ H.

FIG. 6 is an illustration of the swing plate according to the present invention. As shown in the figure, for the swing plate provided on the drainage plate 23, the drive sprocket rotates with the rotation of the chip carrying conveyor, this rotation causes rotation of the swing plate 24 by a cam 27 via an arm 28, and the chips 25 accumulated on the drainage plate 23 are moved to the side of the discharge port 8 and discharged. Reference numeral 29 denotes a spring for returning the swing plate 24 to the original state after the rotation of the drive sprocket causes the rotation of the swing plate 24 by the cam 27 via the arm 28 to move the accumulated chips 25 to the side of the discharge port 8. The operation for discharging the chips accumulated on the drainage plate is not limited to the above as long as the swing plate can rotate or reciprocate to move the chips accumulated on the drainage plate to the discharge port.

On the other hand, as described above, in the present invention, the drainage plate 23 is provided in the upper right direction relative to the horizontal direction. Thus, when the chips carried by the chip carrying conveyor drop immediately below the drive sprocket 3 by the rotation of the drive sprocket 3, oil and water of the chips 25 accumulated on the drainage plate 23 can be completely drained. The drainage plate 23 is provided in the upper right direction relative to the horizontal direction, and thus the chips are highly likely to drop on the lower side in the treatment tank 1 opposite from the discharge port 8, and the amount of dropping chips is larger than that when the drainage plate 23 is horizontally placed.

For the chips large in amount dropping on the lower side in the treatment tank 1, the bucket 6 is provided on the inside of the carrying conveyor 2, which is the feature of the present invention, and thus the chips accumulated on the bottom of the treatment tank 1 and the chips accumulated on the conveyor tail side can be collected by the bucket 6 and discharged to the outside of the conveyor. Specifically, the bucket 6 is particularly provided on the conveyor plate to allow the small chips accumulated on the bottom of the treatment tank 1 and on the conveyor tail side in inverse running at the conveyor tail part to be scooped by the bucket 6, carried with the large chips by the carrying side belt running on the upper side, and discharged to the outside of the conveyor.

### INDUSTRIAL APPLICABILITY

As described above, the drainage plate of the chips is provided in the chip carry-out part according to the present invention, and the swing plate is provided, thereby facilitating discharge of the chips accumulated on the drainage plate at the chip carry-out part. Also, the bucket is provided on the inside of the carrying conveyor to prevent the chips from being accumulated at the conveyor tail part to prevent liquid from being carried out with discharge of the chips and dust, and allow the chip discharge device to be operated for a long period without special maintenance. This device is suitable for use in similar devices.

The present invention is not limited to the embodiment, and various changes or variations may be made without departing from the sprit and scope of the present invention. Therefore, claims described below are appended to make the scope of the present invention open to public.

This application claims the priority of Japanese Patent Application No. 2004-211169 filed on Jul. 20, 2004 and Japanese Patent Application No. 2004-211170 filed on Jul. 20, 2004, and the descriptions thereof are entirely incorporated herein.

1. A chip carrying type filtration device comprising:
an apron type conveyor inversed on a conveyor tail part side and a chip carry-out part side and rotatingly running; and
a filtration drum disposed on the inside of said apron type conveyor,
wherein a bucket is installed on the inside of said apron type conveyor and, after the chips accumulated at the conveyor tail part are collected by the rotation of said conveyor, the chips are discharged to the outside of said conveyor, and an opening part for flowing out the cutting lubricant after being filtrated by a filtration filter to the outside of said storage tank is formed in the filtration drum.

2. The chip carrying type filtration device according to claim 1, wherein a backwash nozzle for washing the filtration filter and a nozzle for discharging the chips are provided in the filtration drum in the chip carrying type filtration device.

3. The chip carrying type filtration device according to claim 1, wherein chip scraping plates are provided at regular intervals on a chain ring.

4. A chip carrying type chip discharge device inversed on a conveyor tail part side and a chip carry-out part side and rotatingly running,
wherein a distance H from a carrying conveyor is provided in said chip carry-out part, and a drainage plate is provided to protrude by a length L from the tip of a drive sprocket in a right upper direction relative to a horizontal direction.

5. The chip carrying type chip discharge device according to claim 4, wherein a swing plate is provided on the drainage plate, rotation of the drive sprocket causes rotation or reciprocation of said swing plate to discharge chips accumulated on the drainage plate from the tip of the drainage plate.

6. The chip carrying type chip discharge device according to claim 4, wherein a bucket is installed on the inside of the carrying conveyor and, after the chips accumulated at the conveyor tail part are collected by the rotation of said conveyor, the chips are discharged to the outside of said conveyor.

7. The chip carrying type chip discharge device according to claim 5, wherein a bucket is installed on the inside of the carrying conveyor and, after the chips accumulated at the conveyor tail part are collected by the rotation of said conveyor, the chips are discharged to the outside of said conveyor.
